(19) United States
(12) Patent Application Publication
(10) Pub. No.: US 2025/0368139 A1
(43) Pub. Date: Dec. 4, 2025

(54) RAIL ASSEMBLY

(71) Applicants: HYUNDAI MOTOR COMPANY, SEOUL (KR); KIA CORPORATION, SEOUL (KR); HYUNDAI TRANSYS INC., SEOSAN-SI (KR); ECOPLASTIC CORPORATION, GYEONGJU-SI (KR)

(72) Inventors: Cheon Ho Kim, Hwaseong-si (KR); Byoung Wook Kim, Hwaseong-si (KR); Jung Yoon Jang, Hwaseong-si (KR); Byung Yong Choi, Hwaseong-si (KR); In Gul Baek, Yongin-si (KR); Yong Seong Jang, Gunpo-si (KR); Chan Ju Kim, Gunpo-si (KR); Song Hee Bae, Hwaseong-si (KR); Dong Jin Park, Daegu (KR); Jong Heon Lee, Suwon-si (KR); Hae Ju Park, Gyeongju-si (KR)

(73) Assignees: HYUNDAI MOTOR COMPANY, SEOUL (KR); KIA CORPORATION, SEOUL (KR); HYUNDAI TRANSYS INC., SEOSAN-SI (KR); ECOPLASTIC CORPORATION, GYEONGJU-SI (KR)

(21) Appl. No.: 18/924,203

(22) Filed: Oct. 23, 2024

(30) Foreign Application Priority Data
Jun. 4, 2024 (KR) 10-2024-0072783

(51) Int. Cl. B60R 7/04; B60R 11/00

(52) U.S. Cl. CPC B60R 7/04; B60R 2011/0007; B60R 2011/0084

(57) ABSTRACT

A rail assembly is configured to reduce space required for lever operation and to reduce noise caused by the lever operation. The rail assembly includes a fixed rail, a movable rail slidably assembled with the fixed rail, a lock module mounted on the movable rail and configured to lock the movable rail to the fixed rail by being coupled to a fixed locking rail mounted on the fixed rail, and a lever module mounted on the movable rail and configured to selectively release coupling between the fixed locking rail and the lock module, wherein the lever module includes a lever housing mounted on the movable rail, and a sliding lever slidably mounted in the lever housing and configured to separate the lock module from the fixed locking rail when horizontally moved in a first direction.

### CROSS REFERENCE TO RELATED APPLICATIONS

This application claims, under 35 U.S.C. § 119(a), the benefit of priority from Korean Patent Application No. 10-2024-0072783, filed on Jun. 4, 2024, the entire contents of which are incorporated herein by reference.

### BACKGROUND

### (a) Technical Field

The present disclosure relates to a rail assembly, and more particularly, to a rail assembly configured to perform linear movement of a moving object such as a movable console for a vehicle.

### (b) Background Art

Generally, a center console installed on a floor panel is provided between seats in the first row of a vehicle. The center console is usually used as a storage space to store items.

As a conventional center console, there are two types of consoles such as a fixed console that is not movable and a movable console that is movable in the forward-and-rearward direction. Forward-and-rearward movement of the movable console is performed by a console rail provided in the movable console.

The conventional console rail has a structure in which locking of the console rail is released by operation of a lever. Here, the lever is operated by force applied thereto in the upward-and-downward direction. In this case, the lever is configured to move upwards so as to release locking of the console rail.

However, since the lever is formed to have a long fork shape, a long locking stroke is required, relatively loud operating noise is generated, and a large operating space is required.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a rail assembly configured to reduce a space required to operate a lever and to reduce noise caused by operation of the lever.

The objects of the present disclosure are not limited to the above-mentioned objects, and other technical objects not mentioned herein will be clearly understood by those skilled in the art to which the present disclosure pertains from the detailed description of the embodiments.

In one aspect, the present disclosure provides a rail assembly including a fixed rail, a movable rail slidably assembled with the fixed rail, a lock module mounted on the movable rail and configured to lock the movable rail to the fixed rail by being coupled to a fixed locking rail mounted on the fixed rail, and a lever module mounted on the movable rail and configured to selectively release coupling between the fixed locking rail and the lock module, wherein the lever module include a lever housing mounted on the movable rail, and a sliding lever slidably mounted in the lever housing and configured to separate the lock module from the fixed locking rail when horizontally moved in a first direction.

In another embodiment, the lever module may include a plurality of rollers adjacent to the sliding lever and axially rotatably mounted on the lever housing.

In another embodiment, the lever module may further include a lever spring mounted between the sliding lever and the lever housing and configured to be compressed when the sliding lever is horizontally moved in the first direction.

In still another embodiment, the lock module may include a switch housing coupled to the movable rail, a lock switch vertically movably inserted into the switch housing and configured to move downwards in conjunction with movement of the sliding lever in the first direction, and a lock plate configured to be separated from the fixed locking rail when the lock switch is moved downwards.

In yet another embodiment, the lock switch may include a first end formed to protrude upwards from the movable rail and selectively disposed adjacent to the sliding lever, and a second end formed to protrude downwards from the switch housing and coupled to the lock plate.

In still yet another embodiment, the sliding lever may have an inclined surface selectively adjacent to the first end of the lock switch.

In a further embodiment, the lock module may further include a lock spring mounted in the switch housing and configured to be compressed by the lock switch when the lock switch is moved downwards in conjunction with the movement of the sliding lever in the first direction.

In another further embodiment, the fixed locking rail may have a plurality of locking grooves arranged in a movement direction of the sliding lever, and the lock plate may have a plurality of locking teeth respectively inserted into and locked in the plurality of locking grooves.

In still another further embodiment, the locking teeth may be configured to be separated from the respective locking grooves when the lock switch is moved downwards by the sliding lever.

In yet another further embodiment, the lock module may further include a movable locking rail mounted on the movable rail and inserted into and located in the fixed locking rail, the movable locking rail may have a plurality of openings configured to guide movement of the locking teeth, and the locking teeth may penetrate the respective openings so as to be inserted into the respective locking grooves.

In still yet another further embodiment, the movable rail may have a movable rail stopper mounted thereon and configured to limit movement of the movable rail in a second direction, and the fixed rail may have a fixed rail stopper configured to stop, at a predetermined position, the movable rail stopper moving with the movable rail.

In a still further embodiment, at least one of the movable rail stopper and the fixed rail stopper may include a first rubber damper configured to reduce noise generated when colliding with the other rail stopper.

In a yet further embodiment, the lever housing may have a housing stopper formed to pass through the movable rail so as to extend toward the fixed rail, and the housing stopper may be configured to stop, when the movable rail is moved in the first direction, the movable rail at a predetermined position through collision with the fixed rail stopper.

In a still yet embodiment, at least one of the fixed rail stopper and the housing stopper may include a second rubber damper configured to reduce noise generated when colliding with the other stopper.

Other aspects and embodiments of the disclosure are discussed infra.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a combined perspective view showing a rail assembly according to an embodiment of the present disclosure;

FIG. 2 is a perspective view showing a fixed part of the rail assembly according to the embodiment of the present disclosure;

FIG. 3 is a perspective view showing a moving part of the rail assembly according to the embodiment of the present disclosure;

FIG. 4 is an exploded perspective view showing a lever module of the rail assembly according to the embodiment of the present disclosure;

FIG. 5 is a cut-away perspective view showing the lever module of the rail assembly according to the embodiment of the present disclosure;

FIG. 6 is an exploded perspective view showing a lock module of the rail assembly according to the embodiment of the present disclosure;

FIG. 7 is a cross-sectional view showing the lock module of the rail assembly according to the embodiment of the present disclosure;

FIG. 8 is a cross-sectional view showing the lever module of the rail assembly according to the embodiment of the present disclosure;

FIGS. 9, 10, and 11 are views each showing an interlocking structure between the lever module and the lock module of the rail assembly according to the embodiment of the present disclosure;

FIGS. 12 and 13 are views each showing a locking mechanism of the rail assembly according to the embodiment of the present disclosure;

FIGS. 14 and 15 are views each showing a stopping structure of the rail assembly according to the embodiment of the present disclosure; and

FIGS. 16A and 16B are views showing a comparison result between movement distances of a lock switch depending on slope conditions of a sliding lever according to the embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. Further, the matters represented in the accompanying drawings are schematically illustrated in order to easily explain the embodiments of the present disclosure, and may be different from actually implemented forms.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

Additionally, in this specification, “forward”, “rearward”, “upward”, and “downward” directions may be described in consideration of a vehicle structure. For example, when a rail assembly of the present disclosure is installed between a movable console for a vehicle and a floor panel of a vehicle body so as to support linear movement of the movable console, a movement direction of a component provided in the rail assembly may be described as a forward direction, a rearward direction, an upward direction, a downward direction, and the like.

Furthermore, in this specification, a “horizontal” direction may be used to include a “forward-and-rearward” direction, and a “vertical” direction may be used to include an “upward-and-downward” direction.

In addition, as used herein, expressions such as “comprise”, “include”, and “provided” may not mean excluding other components but may mean further including or comprising other components.

The present disclosure relates to a rail assembly configured to be unlocked by operation of a lever, and more particularly, to a rail assembly configured to reduce operating noise generated when the rail assembly is unlocked and to reduce operating space required when the rail assembly is unlocked.

The rail assembly of the present disclosure is configured to be locked and unlocked by sliding a lever. Accordingly, an operating stroke amount of the lever is reduced as compared with the related art, and problems related to operating noise and operating space are solved.

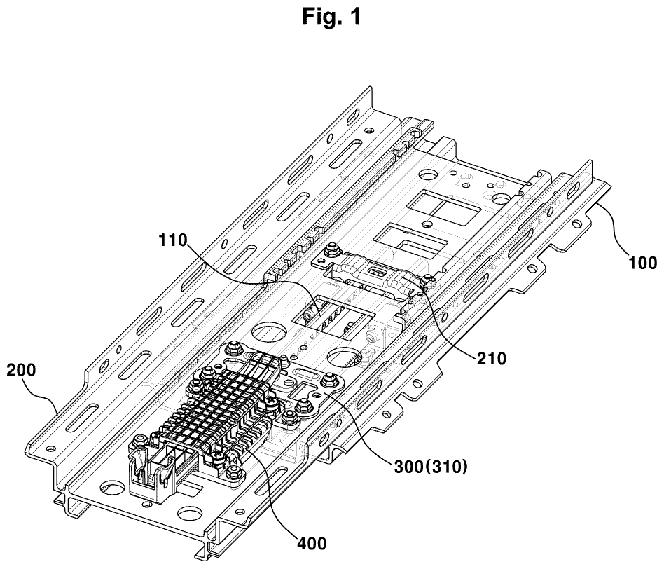

The rail assembly according to the embodiment of the present disclosure is broadly formed of a fixed part and a moving part. Referring to FIGS. 1 to 3, the fixed part includes a fixed rail 100, a fixed locking rail 110, and a fixed rail stopper 120, and the moving part includes a movable rail 200, a lock module 300, and a lever module 400.

Although not specifically shown in the drawings, a bearing is installed between the fixed part and the moving part. The bearing is a sliding auxiliary means to support and assist sliding of the movable rail 200 and allows the movable rail 200 to slide without any clearance relative to the fixed rail 100.

The fixed rail 100 is fixedly installed in a space in which the rail assembly of the present disclosure is installed. For example, the rail assembly of the present disclosure may be fixedly installed on one side of a vehicle body in which a movable console for a vehicle is to be installed, thereby performing linear movement of the movable console. Specifically, the fixed rail 100 may be fixedly installed on a floor panel of the vehicle body in which a main body of the movable console (for example, a console main body or a console box) is to be installed.

When applied to a console main body, the rail assembly according to the embodiment of the present disclosure may be installed between the console main body and the floor panel so as to support horizontal movement of the console main body. Of course, the rail assembly of the present disclosure may be applied to other moving objects in addition to the movable console for the vehicle. In this case, the moving object is slidably supported by the rail assembly.

The movable rail 200 is slidably assembled with the fixed rail 100. In this case, the movable rail 200 is configured to linearly move in a first direction and a second direction relative to the fixed rail 100. The first direction is opposite the second direction. For example, when the rail assembly of the present disclosure is applied to the console main body of the vehicle, the first direction may refer to a rearward direction, and the second direction may refer to a forward direction.

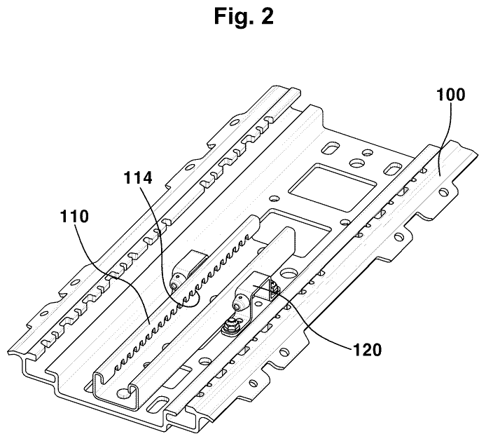

Referring to FIG. 2, the fixed rail 100 has the fixed locking rail 110 mounted thereon and configured to lock and limit sliding of the movable rail 200.

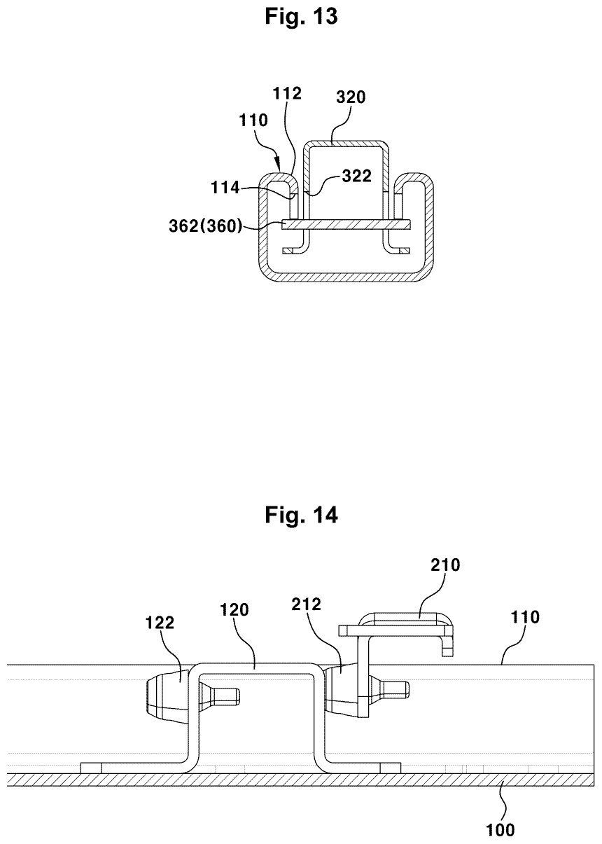

The fixed locking rail 110 is coupled to the lock module 300 fixedly mounted on the movable rail 200, thereby making it possible to lock sliding of the movable rail 200. Specifically, the fixed locking rail 110 is coupled to a lock plate 360 of the lock module 300 so as to limit linear movement of the movable rail 200 (refer to FIG. 12).

The lock module 300 may be selectively coupled to or separated from the fixed locking rail 110 by a sliding lever 420 of the lever module 400, thereby making it possible to restrain sliding movement of the movable rail 200 or to release locking of the movable rail 200.

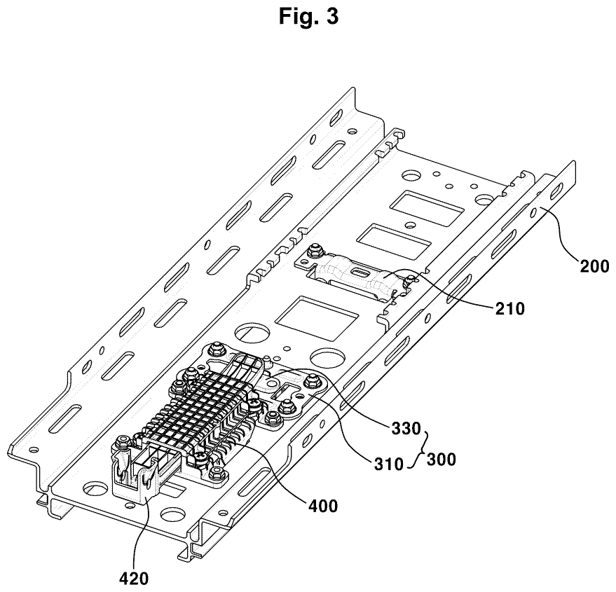

As shown in FIG. 3, the lever module 400 is mounted on the movable rail 200 and is configured to selectively release coupling between the fixed locking rail 110 and the lock module 300. When coupling between the fixed locking rail 110 and the lock module 300 is released, the movable rail 200 having the lock module 300 mounted thereon may be moved in the first direction.

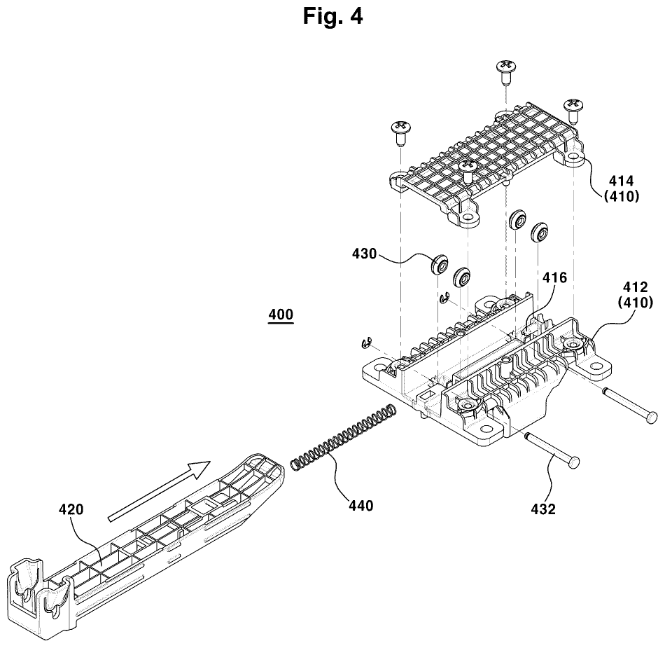

As shown in FIG. 4, the lever module 400 includes a lever housing 410 fixedly mounted on the movable rail 200 and a sliding lever 420 slidably mounted in the lever housing 410.

The lever housing 410 includes a first housing 412 directly mounted on the movable rail 200 and a second housing 414 stacked on and coupled to one side (that is, the upper side) of the first housing 412. The lever housing 410 has an internal space configured to allow the sliding lever 420 to be slidably inserted thereinto and disposed therein.

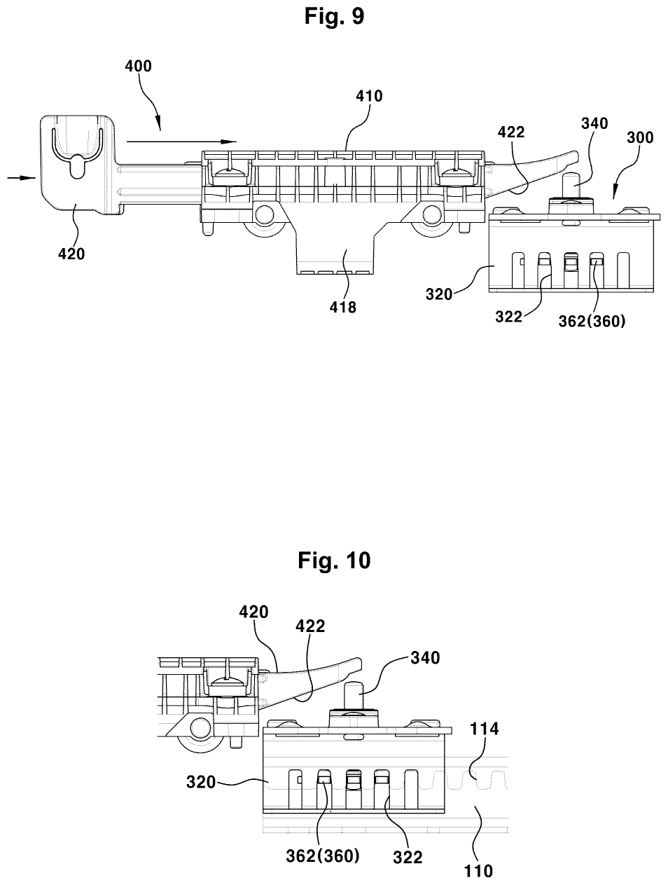

Additionally, as shown in FIGS. 4 and 8, the lever housing 410 includes a plurality of rollers 430 configured to enable linear movement of the sliding lever 420. The rollers 430 are axially rotatably assembled with the first housing 412 through coupling pins 432 and are configured to be adjacent to one surface (that is, lower surface) of the sliding lever 420 inserted into and disposed in the lever housing 410.

Accordingly, when external force for movement in the first direction is applied to the sliding lever 420, the sliding lever 420 slides on the rollers 430 and moves horizontally in the first direction.

The initial and basic mode of the rail assembly according to the present disclosure is set to a locking mode. In this case, the lock plate 360 of the lock module 300 is locked to the fixed locking rail 110 and a movable locking rail 320 (refer to FIGS. 10 and 12). The locking mode of the rail assembly is released when the sliding lever 420 is linearly moved in the first direction. The first direction is a direction in which the sliding lever 420 is moved to release locking of the rail assembly. When the rail assembly is applied to the movable console of the vehicle, the first direction may mean the rearward direction.

Additionally, the sliding lever 420 may be moved in the first direction by user operation. For example, a user may move the sliding lever 420 in the first direction by operating a movable knob provided on the main body of the movable console. Although not specifically shown, the movable knob may linearly move the sliding lever 420 through a connecting rod connected to the sliding lever 420. Since this is a general technique for operating the sliding lever 420 using the movable knob and connecting rod, a detailed description thereof will be omitted. Additionally, a knob to move the sliding lever 420 is not limited to the movable knob. For example, the sliding lever 420 may be moved in the first direction by an electric knob and may also be combined with a knob adopting various operating methods.

The sliding lever 420 is configured to separate, when slidably moving in the first direction, the lock module 300 from the fixed locking rail 110. When external force for movement in the first direction (that is, operating force of the movable knob) is removed, the sliding lever 420 may move horizontally in the second direction and may return to the original position thereof.

The lever module 400 further includes a lever spring 440 configured to enable the sliding lever 420 to return to the original position thereof. The lever spring 440 is configured to generate elastic restoring force while being compressed when the sliding lever 420 slides in the first direction.

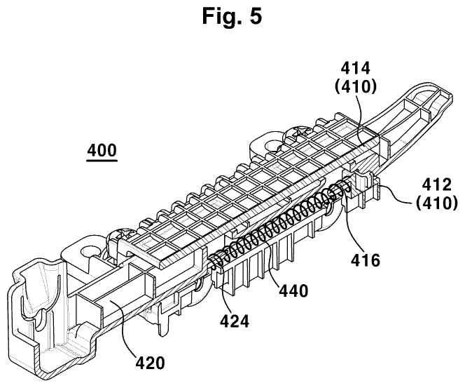

To this end, the lever spring 440 is installed between the lever housing 410 and the sliding lever 420. Referring to FIG. 5, the lever spring 440 is mounted between a spring support part 416 provided in the lever housing 410 and a support protrusion 424 provided on the sliding lever 420. Here, the lever spring 440 has a first end coupled to the spring support part 416 and a second end coupled to the support protrusion 424.

More specifically, the spring support part 416 is provided on one side of the first housing 412, and the support protrusion 424 is provided on one side of the sliding lever 420. In a state in which the sliding lever 420 is assembled with the lever housing 410, the spring support part 416 and the support protrusion 424 face each other.

Accordingly, the lever spring 440 is compressed when the sliding lever 420 slides in the first direction and is restored when external force applied to the sliding lever 420 is eliminated, thereby causing the sliding lever 420 to slide in the second direction.

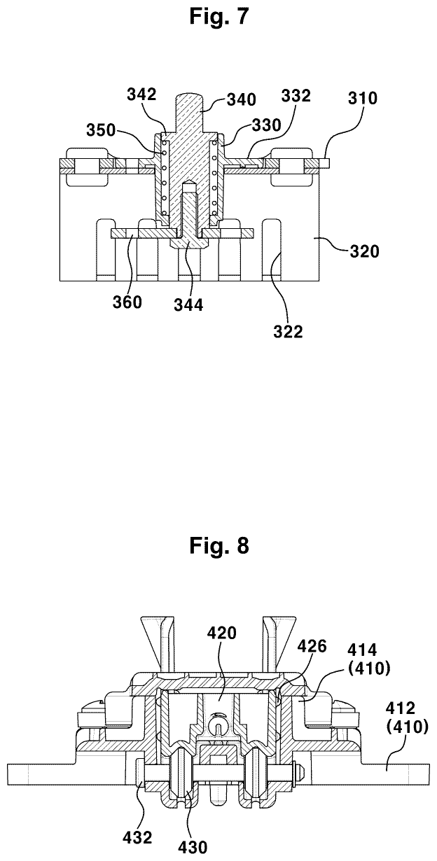

When the sliding lever 420 returns to the original position thereof by the lever spring 440, a lock switch 340 of the lock module 300 returns to the original position thereof by the lock spring 350 (refer to FIG. 7). In this case, locking teeth 362 of the lock plate 360 are respectively reinserted into locking grooves 114 of the fixed locking rail 110 so as to return the original position thereof (refer to FIG. 12).

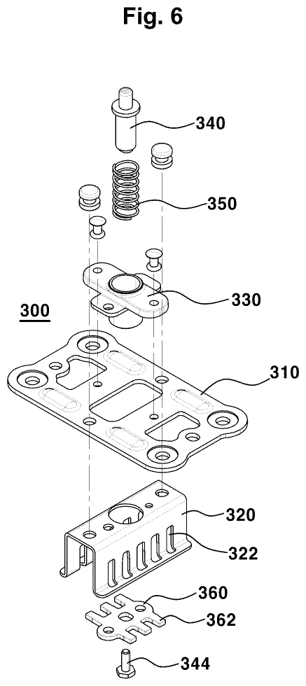

The lock module 300 is configured to release locking of the movable rail 200 in conjunction with movement of the sliding lever 420 in the first direction. As shown in FIG. 6, the lock module 300 includes the movable locking rail 320, a switch housing 330, the lock switch 340, and the lock plate 360.

Referring to FIGS. 1 and 7, the movable locking rail 320 and the switch housing 330 are mounted on and fixed to the movable rail 200 through a lock module bracket 310. The movable locking rail 320 and the switch housing 330 may be more stably coupled to the movable rail 200 by being coupled to the movable rail 200 with the plate-shaped lock module bracket 310. The lock module bracket 310 serves as a support to support components of the lock module 300.

More specifically, the movable locking rail 320 is coupled to the lock module bracket 310 with a rivet in a state of being stacked and disposed on the lower side of the lock module bracket 310. The switch housing 330 is coupled to the lock module bracket 310 with a rivet in a state of penetrating the lock module bracket 310. The lock module bracket 310 is coupled to the movable rail 200 in a state of being stacked on the upper side of the movable rail 200.

In this case, the movable locking rail 320 and the switch housing 330 are disposed on the lower side of the movable rail 200 by penetrating the movable rail 200 in a state of being coupled to the lock module bracket 310. Further, the movable locking rail 320 is disposed below a first surface of the movable rail 200, and the lock module bracket 310 is stacked and disposed on a second surface of the movable rail 200. The first surface is a surface of the movable rail 200 that faces the fixed rail 100 when the movable rail 200 is stacked on the fixed rail 100, and the second surface is a surface opposite the first surface.

The movable rail 200 is a plate structure having a curved shape so as to be slidably assembled with the fixed rail 100. The first surface of the movable rail 200 faces the fixed rail 100, and the second surface thereof faces the opposite side of the fixed rail 100.

The movable locking rail 320 has a cross-sectional structure that is bent approximately in the inverted U-shape, and more specifically, has a square cross-sectional structure having an open lower end. The movable locking rail 320 has a plurality of openings 322 formed in opposite sides thereof and is inserted into and disposed in the fixed locking rail 110 (refer to FIG. 12).

The openings 322 of the movable locking rail 320 are provided to guide third movement and fourth direction movement of the locking teeth 362 provided on the lock plate 360. Movement of the lock plate 360 is guided through the openings 322 and the locking teeth 362, thereby stably moving the lock plate 360 without shaking. The locking teeth 362 pass through the respective openings 322 so as to be inserted into the respective locking grooves 114 of the fixed locking rail 110.

In this specification, the openings 322 may be referred to as guide holes. Additionally, in this specification, the third direction and the fourth direction may mean the upward direction and the downward direction, respectively. For example, when the rail assembly of the present disclosure is applied to the movable console of the vehicle, the third direction may mean the downward direction of the vehicle, and the fourth direction may mean the upward direction of the vehicle. Additionally, the third and fourth directions are directions perpendicular to the first and second directions, which are the movement directions of the movable rail 200.

The fixed locking rail 110 has a cross-sectional structure that is curved approximately in an inverted U-shape, and more specifically, has a square cross-sectional structure having an open upper end. In order to allow at least a portion of the movable locking rail 320 to be inserted to the fixed locking rail 110, the fixed locking rail 110 is mounted on the fixed rail 100 such that the upper end thereof faces the movable rail 200.

The openings 322 of the movable locking rail 320 are penetrated by the locking teeth 362 of the lock plate 360. The lock plate 360 is a plate-shaped structure including a plurality of the locking teeth 362 and is coupled and fixed to the lower end of the lock switch 340.

The lock switch 340 is configured to move in a direction in which locking of the movable rail 200 is released in conjunction with movement of the sliding lever 420 in the first direction. To this end, the lock switch 340 has an upper end that may contact, when the sliding lever 420 is moved in the first direction, an inclined surface 422 of the sliding lever 420 and may be pressed against the inclined surface 422. In this specification, the upper end of the lock switch 340 may be referred to as a first end, and the lower end of the lock switch 340 may be referred to as a second end.

The inclined surface 422 is provided at the rear end (that is, a first end) of the sliding lever 420 and has a predetermined inclination. An inclination of the inclined surface 422 is adjusted, thereby adjustably determining the operating speed of the lock switch 340.

The lock switch 340 has a rod-shaped structure, and a spring support 342 is provided at a center portion between the first and second ends of the lock switch 340. The lock switch 340 is movably assembled with the switch housing 330 and is mounted on the movable rail 200 through the switch housing 330.

The switch housing 330 is formed to have a hollow cylindrical structure and has a housing bracket 332 stacked on and coupled to the upper surface of the lock module bracket 310. The switch housing 330 is coupled to the movable rail 200 through the lock module bracket 310. Additionally, the switch housing 330 has a lock spring 350 inserted thereinto and mounted therein and configured to elastically support the lock switch 340. The lock spring 350 is disposed between the spring support 342 of the lock switch 340 and the lower end of the switch housing 330.

This switch housing 330 has a fully open upper end (that is, a first end) and a partially open lower end (that is, a second end). The first end of the switch housing 330 is open to have a diameter larger than diameters of the spring support 342 and the lock spring 350 so as not to interfere with movement of the spring support 342. The second end of the switch housing 330 is open to have a diameter smaller than the diameter of the lock spring 350 so as to support one end of the lock spring 350. Opposite ends of the lock spring 350 may be coupled to the second end of the switch housing 330 and the spring support 342.

Accordingly, the lock switch 340 is inserted thereinto and assembled with the switch housing 330 in a state of being elastically supported by the lock spring 350. In this case, the lock switch 340 is assembled to be linearly movable within the switch housing 330 in a state of penetrating the switch housing 330.

The lock switch 340 is movable vertically in the third direction in conjunction with movement of the sliding lever 420 in the first direction. Further, when the sliding lever 420 is moved in the second direction, the lock switch 340 may be moved vertically in the fourth direction by elastic restoring force of the lock spring 350 and may return to the original position thereof.

Here, the third direction is a direction in which the lock switch 340 is moved to release locking of the movable rail 200, and the fourth direction is a direction in which the lock switch 340 is moved to lock the movable rail 200. When the rail assembly of the present disclosure is applied to the movable console of the vehicle, the third direction may mean the downward direction, and the fourth direction may mean the upward direction.

Additionally, the first end and the second end of the lock switch 340 protrude out of the switch housing 330. The first end of the lock switch 340 protrudes upwards from the movable rail 200 and the switch housing 330 so as to selectively contact the inclined surface 422 of the sliding lever 420, and the second end of the lock switch 340 protrudes downwards from the switch housing 330 so as to be coupled to the lock plate 360.

The lock switch 340 is supported in a state of penetrating the movable locking rail 320 and the movable rail 200 in the first direction through the switch housing 330. In this case, the first end of the lock switch 340 protrudes toward the opposite side of the fixed rail 100, and the second end of the lock switch 340 protrudes toward the fixed rail 100.

As shown in FIGS. 6 and 7, the lock plate 360 is coupled to the second end of the lock switch 340 through a bolt 344. Accordingly, the lock plate 360 is moved with the lock switch 340 in the third and fourth directions. When the rail assembly of the present disclosure is in the locking mode, that is, when the sliding lever 420 is in the initial position, the lock plate 360 is located closest to the second end of the switch housing 330.

As shown in FIGS. 10 and 12, the locking teeth 362 of the lock plate 360 penetrate the respective openings 322 of the movable locking rail 320 so as to be inserted into and coupled to the respective locking grooves 114 of the fixed locking rail 110.

The fixed locking rail 110 has a plurality of locking grooves 114 on opposite side walls thereof, and the plural locking grooves 114 are arranged in the movement direction of the sliding lever 420. The locking grooves 114 extend in the movement direction of the lock switch 340. The arrangement direction and the extension direction of the locking grooves 114 are the same as or similar to the arrangement direction and the extension direction of the openings 322. Here, the movement direction of the sliding lever 420 may refer to the forward-and-rearward direction of the vehicle, and the movement direction of the lock switch 340 may refer to the upward-and-downward direction of the vehicle.

More specifically, the locking grooves 114 extend in the third direction, and linear movement of the locking teeth 362 is performed within the locking grooves 114. Each of the locking grooves 114 has a length shorter than that of each of the openings 322 of the movable locking rail 320 in the third direction by a predetermined value or more.

Additionally, the length of each of the locking grooves 114 is shorter than a movement distance of the lock switch 340 for unlocking of the movable rail 200. More specifically, when the lock switch 340 is moved in the third direction (that is, toward the fixed rail 100) in conjunction with movement of the sliding lever 420 in the first direction, the movement distance of the lock switch 340 in the third direction is larger than the length of each of the locking grooves 114 in the third direction.

Therefore, when the lock switch 340 is moved in the third direction by the sliding lever 420, the locking teeth 362 of the lock plate 360 respectively pass through the open lower ends (that is, unlocked portions) of the locking grooves 114 and protrude out of the locking grooves 114 (refer to FIGS. 11 and 13).

Referring to FIGS. 11 and 13, when movement of the lock switch 340 in the third direction is completed, the locking teeth 362 are completely separated from the respective locking grooves 114. When the locking teeth 362 are separated from the respective locking grooves 114, coupling between the lock plate 360 and the fixed locking rail 110 is released, and the lock plate 360 and the fixed locking rail 110 are separated from each other. Accordingly, movement locking of the movable locking rail 320 and the movable rail 200 is released, and the movable rail 200 is movable along the fixed rail 100 in the first direction or the second direction.

In order to separate the locking teeth 362 from the respective locking grooves 114 when the lock switch 340 is moved in the third direction, the locking grooves 114 extend in the movement direction of the lock switch 340 and are formed to have open lower ends. As shown in FIG. 12, opposite side walls of the fixed locking rail 110 respectively have bent portions 112 each extending in an approximately inverted L-shape. Here, each of the locking grooves 114 is formed in a corresponding one of the bent portions 112, and has an opened lower end and a closed upper end. The locking grooves 114 respectively provided on the opposite side walls of the fixed locking rail 110 face the openings 322 of the movable locking rail 320.

In addition, as shown in FIGS. 1 and 2, the fixed rail stopper 120 is mounted on the fixed rail 100, and a movable rail stopper 210 is mounted on the movable rail 200. The movable rail stopper 210 is configured to limit movement of the movable rail 200 in the fourth direction. When moving with the movable rail 200 in the fourth direction, the movable rail stopper 210 comes into contact with the fixed rail stopper 120 and stops.

The fixed rail stopper 120 selectively stops movement of the movable rail 200 and the movable rail stopper 210 in the fourth direction. That is, the fixed rail stopper 120 is configured to stop, when the movable rail 200 reaches a predetermined frontmost position, movement of the movable rail 200 and the movable rail stopper 210 in the fourth direction.

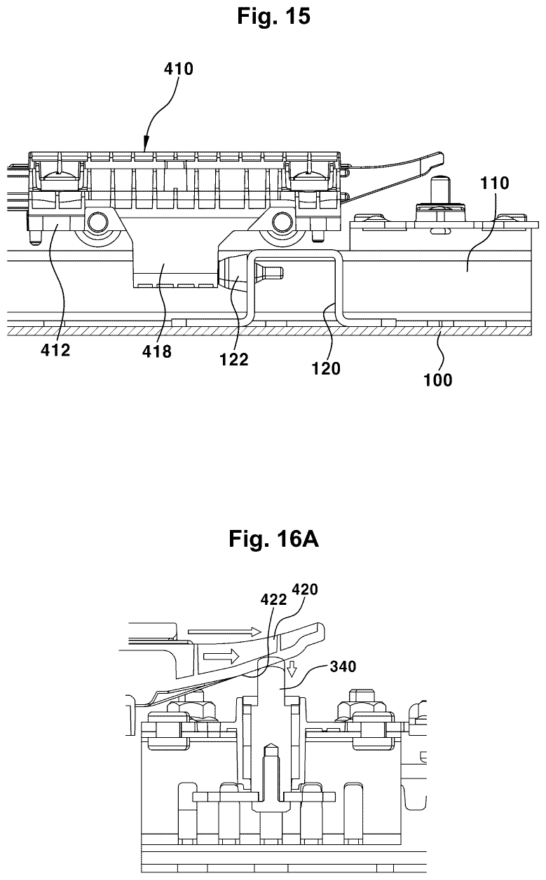

In this case, in order to reduce collision impact and collision noise between the fixed rail stopper 120 and the movable rail stopper 210, at least one of the fixed rail stopper 120 and the movable rail stopper 210 has a first rubber damper 212 disposed at a portion thereof, in which the portion collides with the other rail stopper. Referring to the embodiment shown in FIG. 14, the first rubber damper 212 is provided on the movable rail stopper 210.

Additionally, in order to limit movement of the movable rail 200 in the third direction, the lever housing 410 has a housing stopper 418 formed to pass through the movable rail 200 so as to extend toward the fixed rail 100. As shown in FIG. 15, the housing stopper 418 is provided on the first housing 412 of the lever housing 410 and protrudes downwards from the lower surface of the first housing 412.

When the movable rail 200 reaches a predetermined rearmost position, the housing stopper 418 collides with the fixed rail stopper 120 and stops, thereby making it possible to stop movement of the movable rail 200 in the third direction.

In this case, in order to reduce collision impact and collision noise between the fixed rail stopper 120 and the housing stopper 418, at least one of the fixed rail stopper 120 and the housing stopper 418 has a second rubber damper 122 disposed at a portion thereof, in which the portion collides with the other stopper. Referring to the embodiment shown in FIGS. 14 and 15, the second rubber damper 122 is provided on the fixed rail stopper 120.

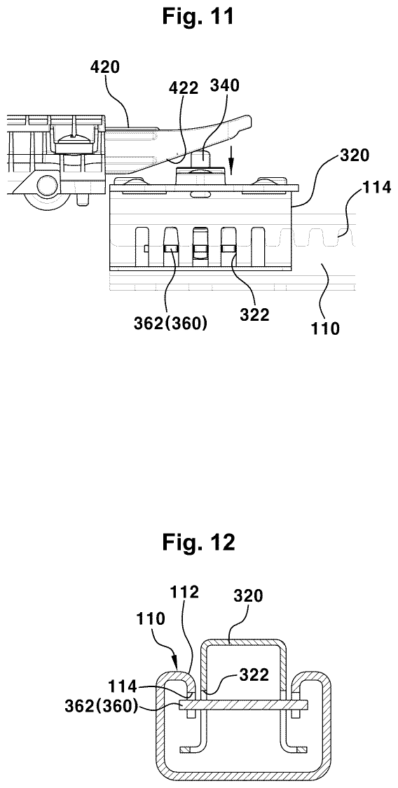

Meanwhile, referring to FIGS. 8 and 9, the sliding lever 420 has a rib 426 protruding from the side surface and the upper surface thereof. In this manner, the sliding lever 420 may be moved forwards and rearwards while minimizing a gap with the lever housing 410 through the rib 426.

FIGS. 9 to 11, when the sliding lever 420 is moved in the first direction (that is, in the rearward direction), the first end of the lock switch 340 and the inclined surface 422 of the sliding lever 420 come into contact with each other. At this time, component force is generated along the slope of the inclined surface 422, and the lock switch 340 is pressed in the third direction (that is, in the downward direction).

As a result, the lock plate 360 coupled to the second end of the lock switch 340 is moved downwards and is disconnected from the fixed locking rail 110 (refer to FIG. 13). When restraint (that is, movement locking) of the lock plate 360 is released, the movable rail 200 is movable forwards and rearwards.

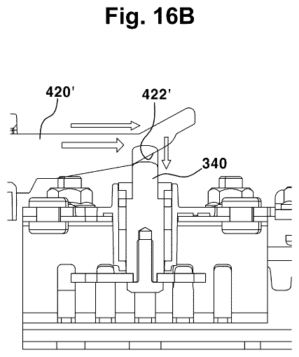

In addition, as shown in FIGS. 16A and 16B, a downward speed of the lock switch 340 and an amount of change in force per unit distance thereof may be adjusted by adjusting the inclination of the inclined surface 422 of the sliding levers 420 or an inclined surface 422′ of a sliding lever 420′.

The inclined surface 422 of the sliding lever 420 shown in FIG. 16A has an inclination angle that is smaller than that of the inclined surface 422′ of the sliding lever 420′ shown in FIG. 16B by 10°. Accordingly, when horizontal movement distances of the sliding levers 420 and 420′ are the same (for example, 10 mm), a downward movement distance of the lock switch 340 shown in FIG. 16A is smaller than that of the lock switch 340′ shown in FIG. 16B. In this manner, an amount of downward movement of the lock switch 340 according to horizontal movement of the sliding lever 420 may be controlled by adjusting an inclination of the inclined surface 422.

Meanwhile, although not specifically shown in the drawings, a rail assembly according to another embodiment of the present disclosure may include a lever module 400 and a lock module 300 mounted on the fixed rail 100, and a fixed locking rail 110 mounted on the movable rail 200.

In addition, the sliding lever 420 may be configured to be movable forwards and rearwards by forming a rib and an embossment on the sliding lever 420 without using the roller 430 and the coupling pin 432 of the lever module 400.

Additionally, the number of locking teeth 362 of the lock plate 360 may be changed to suit any system to which the rail assembly is applied, and the upper surfaces of the locking teeth 362 may be chamfered or rounded.

Furthermore, the shape of the contact surface (that is, the first end) of the lock switch 340 that contacts the inclined surface 422 of the sliding lever 420 may be modified into a rounded shape or a chamfered shape.

As is apparent from the above description, the present disclosure provides a rail assembly having the following effects.

First, the rail assembly adopts an operating mechanism in which a sliding lever is moved by force applied thereto in the horizontal direction (that is, forward-and-rearward direction), thereby making it possible not only to reduce an operating stroke of the sliding lever, but also to reduce operating noise and operating space.

Second, the rail assembly adopts an operating mechanism in which a lock module is moved in the vertical direction in conjunction with linear movement of the sliding lever, thereby making it possible to adjust the operating speed of a lock switch by adjusting an inclination of the inclined surface of the sliding lever.

The effects of the present disclosure are not limited to the above-mentioned effects, and other effects not mentioned herein will be clearly understood by those skilled in the art from the detailed description of the embodiments.

The disclosure has been described in detail with reference to embodiments thereof. Terms and words used in the specification and claims should not be construed as being limited to ordinary or dictionary meanings thereof. Further, the scope of the present disclosure is not limited to the above-described embodiments, and it will be appreciated by those skilled in the art that changes may be made in these embodiments without departing from the principles and spirit of the disclosure, the scope of which is defined in the appended claims and equivalents thereto.

1. A rail assembly comprising:
a fixed rail;
a movable rail slidably assembled to the fixed rail;
a lock module mounted on the movable rail and configured to lock the movable rail to the fixed rail by being coupled to a fixed locking rail mounted on the fixed rail; and
a lever module mounted on the movable rail and configured to release coupling between the fixed locking rail and the lock module;
wherein the lever module comprises:
a lever housing mounted on the movable rail; and
a sliding lever slidably mounted in the lever housing and configured to separate, when horizontally moved in a first direction, the lock module from the fixed locking rail.

2. The rail assembly of claim 1, wherein the lever module further comprises a plurality of rollers adjacent to the sliding lever and axially rotatably mounted on the lever housing.

3. The rail assembly of claim 1, wherein the lever module further comprises a lever spring mounted between the sliding lever and the lever housing and configured to be compressed when the sliding lever is horizontally moved in the first direction.

4. The rail assembly of claim 1, wherein the lock module comprises:
a switch housing coupled to the movable rail;
a lock switch vertically movably inserted into the switch housing and configured to move downwards in conjunction with movement of the sliding lever in the first direction; and
a lock plate configured to be separated from the fixed locking rail when the lock switch is moved downwards.

5. The rail assembly of claim 4, wherein the lock switch comprises:
a first end protruding upwards from the movable rail and disposed adjacent to the sliding lever; and
a second end protruding downwards from the switch housing and coupled to the lock plate.

6. The rail assembly of claim 5, wherein the sliding lever has an inclined surface adjacent to the first end of the lock switch.

7. The rail assembly of claim 4, wherein the lock module further comprises a lock spring mounted in the switch housing and configured to be compressed by the lock switch when the lock switch is moved downwards in conjunction with the movement of the sliding lever in the first direction.

8. The rail assembly of claim 4, wherein:
the fixed locking rail has a plurality of locking grooves arranged in a movement direction of the sliding lever; and
the lock plate has a plurality of locking teeth inserted into and locked in the plurality of locking grooves.

9. The rail assembly of claim 8, wherein the plurality of locking teeth are configured to be separated from each of the plurality of locking grooves when the lock switch is moved downwards by the sliding lever.

10. The rail assembly of claim 8, wherein:
the lock module further comprises a movable locking rail mounted on the movable rail and inserted into and located in the fixed locking rail;
the movable locking rail has a plurality of openings configured to guide movement of the plurality of locking teeth; and
each of the plurality of locking teeth penetrate each of the plurality of openings so as to be inserted into each of the plurality of locking grooves.

11. The rail assembly of claim 1, wherein:
the movable rail comprises a movable rail stopper configured to limit movement of the movable rail in a second direction; and
the fixed rail has a fixed rail stopper configured to stop, at a predetermined position, the movable rail stopper moving with the movable rail.

12. The rail assembly of claim 11, wherein at least one of the movable rail stopper and the fixed rail stopper comprises a first rubber damper configured to reduce noise generated when colliding with an other of the movable rail stopper and the fixed rail stopper.

13. The rail assembly of claim 11, wherein:
the lever housing has a housing stopper passing through the movable rail so as to extend toward the fixed rail; and
the housing stopper is configured to stop, when the movable rail is moved in the first direction, the movable rail at a predetermined position through collision with the fixed rail stopper.

14. The rail assembly of claim 13, wherein at least one of the fixed rail stopper and the housing stopper comprises a second rubber damper configured to reduce noise generated when colliding with on other of the fixed rail stopper and the housing stopper.
